(19) United States
(12) Patent Application Publication
(10) Pub. No.: US 2023/0401646 A1
(43) Pub. Date: Dec. 14, 2023

(54) Document Uniqueness Verification

(71) Applicant: DETECTSYSTEM LAB A/S, Vejle Øst (DK)

(72) Inventors: Jan LOVMAND, Vejle Øst (DK); Lars TORP, Vejle Øst (DK); Rasmus Bækgård HOLM, Vejle Øst (DK)

(73) Assignee: DETECTSYSTEM LAB A/S, Vejle Øst (DK)

(21) Appl. No.: 18/036,186

(22) PCT Filed: Nov. 12, 2021
(86) PCT No.: PCT/EP2021/081471

§ 371 Date: May 10, 2023

Related U.S. Application Data
(60) Provisional application No. 63/113,253, filed on Nov. 13, 2020.

(51) Int. Cl. G06Q 40/08; G06V 30/418; G06F 16/31

(52) U.S. Cl. CPC G06Q 40/08; G06V 30/418; G06F 16/325

(57) ABSTRACT

Reuse of documents to attain fraudulent insurance pay-outs is an increasing global problem. This is alleviated by providing a method (100) of verifying the uniqueness of a digital document by:
identifying and extracting data elements (110) of the document (1),
assigning the document with a document type (120) based on the presence of at least one keyword data element (121) among extracted data elements,
generating a document identifier (130) based on type data (122) being a predetermined plurality of the extracted data elements (110) specific to said document type (120) using an identifier generator algorithm (182),
comparing the generated document identifier (130) with a list (140) of document identifiers (130′) stored in a database (180), where
if the generated document identifier (130) matches a document identifier (130′) in the list, the document (1) is marked as a duplicate document and an alert signal is transmitted.

### FIELD OF THE INVENTION

The invention relates to a method of verifying the uniqueness of a document, a device instructed to perform the method, and a program and a computer-readable medium with instructions for carrying out the method.

### BACKGROUND OF THE INVENTION

Fraud is a global problem that affects not least the insurance industry. It is estimated that 10% of all insurance pay-outs are made to fraudsters. To receive an insurance pay-out, various documents must be presented to validate the insurance claim. Even then, there are loopholes. Fraudsters seek to cheat insurers in a plethora of ways and today, fraud has moved into the digital arena too.

Digital documents introduce a variety of new ways to cheat and commit fraud, not least insurance fraud. Verifying the uniqueness, ownership and authenticity of documents and items is very difficult when documents are digital files. In the past, digital rights management has been used on some file types to ensure that they were not copied, although the inconvenience thereof made it infeasible, and so insecure documents are here to stay. Verifying the uniqueness, ownership and authenticity of documents and items is the job of insurance investigators, who make value-judgments about documents throughout their workday. The more scrutinous they are, the slower and more expensive insurance pay-outs and premiums get. Some insurance companies have decided to solve this by being slack with verification and accepting as high as 20% fraud, since this allows them to have fewer investigators and so retain operative costs low.

Digital documents can be copied indiscriminately. Keeping track of documents can be difficult when a document can be presented in multiple formats such as a scan from a printer, a photo from a mobile phone, or a screenshot from an e-mail, and fraudsters can also re-use the same claim document for multiple cases across different insurance companies.

There is a thus a need for increased security in the pay-out process as well as in verifying document authenticity at large.

### SUMMARY OF THE INVENTION

In an aspect of the invention, there is provided a method of verifying the uniqueness of a digital document by:
identifying and extracting data elements of the document,
assigning the document with a document type based on the presence of at least one keyword data element among data elements,
generating a document identifier based on type data being a predetermined plurality of the extracted data elements specific to said document type using an identifier generator algorithm,
comparing the generated document identifier with a list of document identifiers stored in a database, where
if the generated document identifier matches a document identifier in the list, the document is marked as a duplicate document and an alert signal is transmitted.

Thereby, identical documents having variable layouts or data formats can be matched and fraudsters can be caught.

Although it is conceptually possible to compare all physical documents, it is nevertheless technically impossible, especially since old documents may belong to other persons than the handler of the newly received document. The list of document identifiers is furthermore more persistent than documents which may be lost or damaged. It is also impossible to know if all relevant places has been investigated.

Furthermore, saving document identifiers takes up only little space in a database, and thus the method is energy-saving.

Furthermore, by comparing a document through using a document identifier with a list of historically used/generated document identifiers, a portion of fraud attempts can be stopped in their tracks, freeing up (insurance) investigators to investigate other cases, such as more complicated cases. Yet further, the investigators need to perform fewer mouse-clicks on average to process an insurance claim.

By document is meant a digital file depicting some official or authorised transfer of an item or a right/privilege, documentation or other verification of the state of affairs of the physical or digital world. Typical types of documents are financial documents such as invoices, loans, bills, and medical documents such as journal entry or prescription and personal documents such as driver licenses, social security cards and so on. These documents are exposed to fraud because they offer certain opportunities or benefits. An invoice for an expensive watch allows a fraudster to claim to own the watch, and if s/he can manage the rest of the pay-out claim, s/he can derive economical gain from such document fraud.

The document holds a variety of data necessary for its function. For the sake of this disclosure, the data contents of such document will be termed data element, while the identifier/tag/name of the data is termed the data tag or tag. For example, ‘shipped to’ is the data tag, while ‘Randalf Wayne’ is the data element. When considered together, they are termed the data object. There is also supplementary data being secondary data elements associated with a data element. For example, for the ‘shipped to’ example, the rest of the address is supplementary data.

By an alert signal being transmitted is meant that whoever prompted the method to be performed for a document will receive an alert signal indicative of the document being a duplicate of a previously used document. It is also possible that the alert signal is transmitted to previous such requesters of document uniqueness verification for the specific document. For example, previous insurers may be interested to know that a pay-out might have been fraudulent.

In certain embodiments, the method makes use of hash functions and hash tables. The hash value is a numeric value of a fixed length which uniquely identifies data. For example, SHA-512 can be used. Thereby, even large documents are compressed to small data sizes of only 128 bytes. Furthermore, many documents can be stored and transmitted easily with less amount of space and power consumption. Yet further, it is much faster to query and find a hash match instead of searching across millions of actual documents. Furthermore, because the documents are hashed, the data, which may be identity-sensitive, is not accessible, but it is still possible to see if a document with the same hashed values have been used already. Thereby a secure and effective method is achieved that is furthermore energy-, querying- and storage-efficient.

In an embodiment, generating the document identifier comprises generating a hash based on said type data.

Thereby, it is energy-efficient and fast to make searches through the list of document identifiers. The database is responsive in a timely manner. This ensures that policy holders do not have to wait an inordinate amount of time when requesting a pay-out. Furthermore, it is possible to identify whether the document has been previously used, and so it avoids multiple payouts and thus prevents fraud.

In an embodiment, at least one data element is assigned a context using the arrangement and/or structure of the data element, such as using backslash and dash character spacing of dates and line spacing of addresses.

Thereby, context is assigned based on the data present in the document that is least likely to be assigned erroneously. Thereby the verification process confidence is increased, allowing fewer average mouse-clicks per insurance investigation.

In an embodiment, at least two data elements are assigned contexts by being paired with respective data tags of the extracted text, the pairing of data elements to data tags performed by evaluating at least row-alignment and proximity of the data element and data tag, where each data tag can only pair to a single data element, and where the overall fit of all pairs determines a confidence score of the paring.

In other words, calculations are made that interprets the document for easier pay-out process. Furthermore, it is possible to identify whether the document has been previously used, and so it avoids multiple payouts and thus prevents fraud. Furthermore, context is assigned for a wide variety of document types and irrespective of device layout as well. For example, depending on whether a fraudster has a document on their phone or computer, the horizontal/row-wise layout may vary widely. Ensuring that these two types of document can be identified as the same document allows fewer average mouse-clicks per insurance investigation. Further, policy holders that have the uniqueness of their documents successfully verified through the method are allowed a user-friendly method that can be performed with fewer mouse-clicks by either insurance investigator or the policy holder.

In an embodiment, the type data comprise a tiered predetermined list of data elements ranging from the most preferred to least preferred data element, where the type data is identified in the extracted data elements by first preselecting a plurality of most desired data elements, and where if any of these data elements cannot be found in the extracted data elements, alternate data elements are selected from the tiered list in turn of preference until complete type data is formed.

Thereby sufficiently identifying data contents can be selected, allowing using the method for more fuzzy data situations. Using a tiered list that is automatically used to find useful information allows fewer average mouse-clicks per insurance investigation. Further, policy holders that have the uniqueness of their documents successfully verified through the method are allowed a user-friendly method that can be performed with fewer mouse-clicks by either insurance investigator or the policy holder.

In an embodiment, the method comprises a step of assessing the trust score of the identifying and extracting step to determine whether the document has been analysed with sufficient confidence, and where if the assessing the trust score determines a trust score below a certain threshold, a manual assistance is required to provide data elements including contents.

Thereby, policy holders that have the uniqueness of their documents successfully verified through the method are allowed a user-friendly method that can be performed with fewer mouse-clicks by either insurance investigator or the policy holder. Even when the confidence test of the step of identifying and extracting fails, the insurance investigator is left with a partially completed investigation, which reduces the number of mouse-clicks needed to finish the process.

In an embodiment, the method comprises a step of assessing the trust score of the assigning a document type step to determine whether the document has been assigned a type with sufficient confidence, and where if the assessing the trust score determines a trust score below a certain threshold, a manual assistance is required to provide data elements including contents or manually assigning document type.

Thereby, policy holders that have the uniqueness of their documents successfully verified through the method are allowed a user-friendly method that can be performed with fewer mouse-clicks by either insurance investigator or the policy holder. Even when the confidence test of the step of assigning a document type fails, the insurance investigator is left with a partially completed investigation, which reduces the number of mouse-clicks needed to finish the process.

In an aspect, the invention relates to a computing device having a processor adapted to perform the method of the invention.

In an aspect, the invention relates to a computer program comprising instructions which cause the computer to carry out the method of the invention, when the program is executed by a computer.

In an aspect, the invention relates to a computer-readable medium comprising instructions which cause the computer to carry out the method of the invention, when executed by a computer.

### BRIEF DESCRIPTION OF THE DRAWINGS

In the following, example embodiments are described according to the invention, where

FIG. 1A-1D illustrate first through fourth invoice documents used with an embodiment of the invention,

FIG. 2 illustrates the steps of the method of an embodiment of the invention,

FIG. 3 illustrates a computing device according to an embodiment of the invention, and

FIG. 4 illustrates further detail of assigning a document type of an embodiment of the invention.

### DETAILED DESCRIPTION

In the following the invention is described in detail through embodiments hereof that should not be thought of as limiting to the scope of the invention.

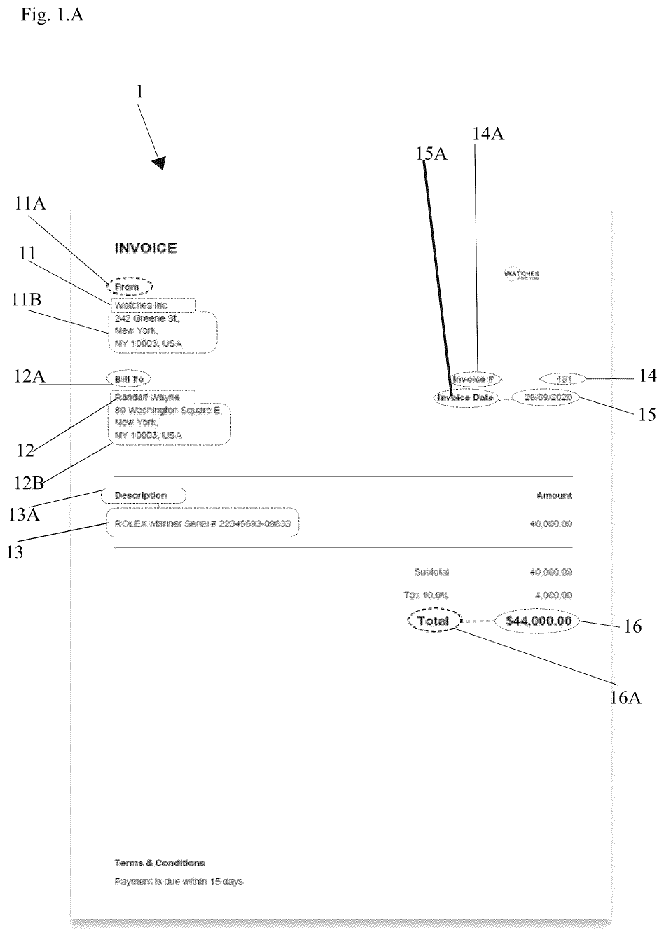

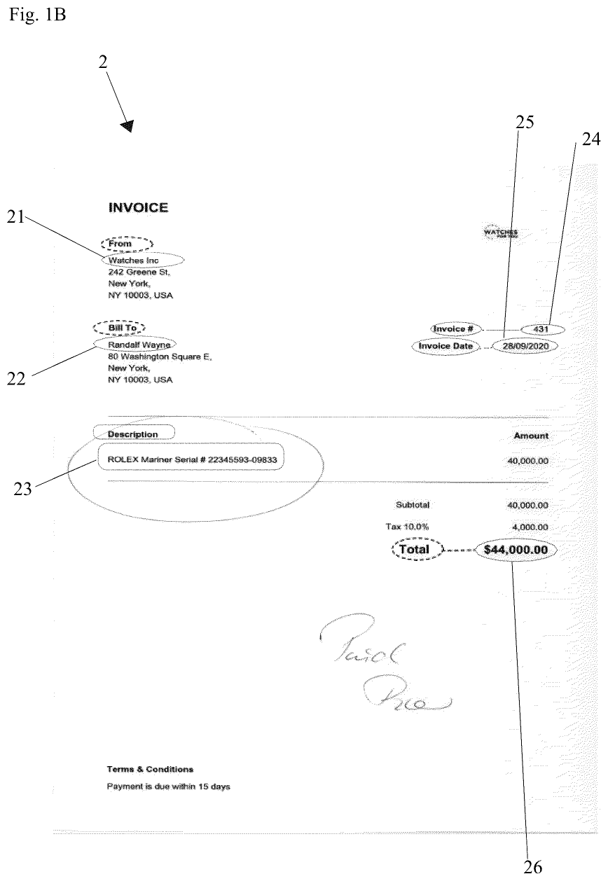

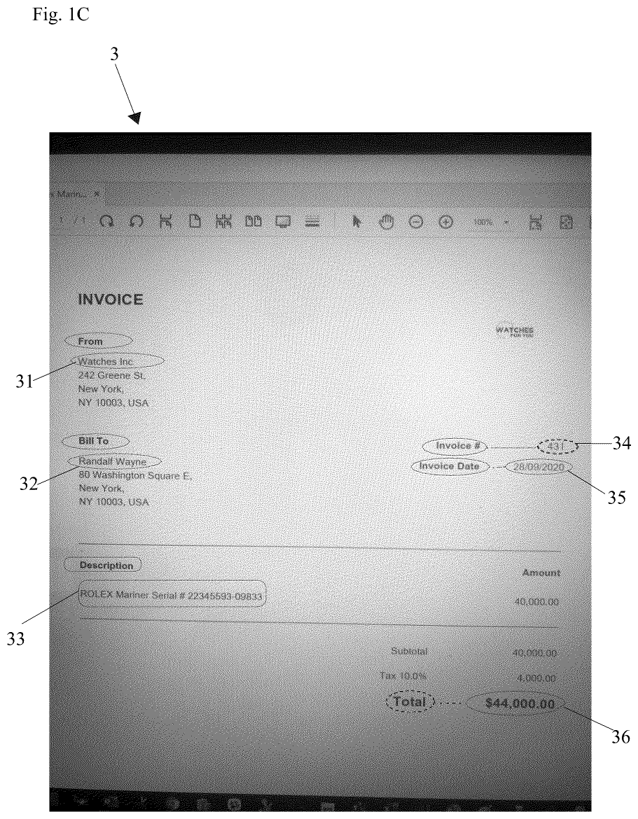

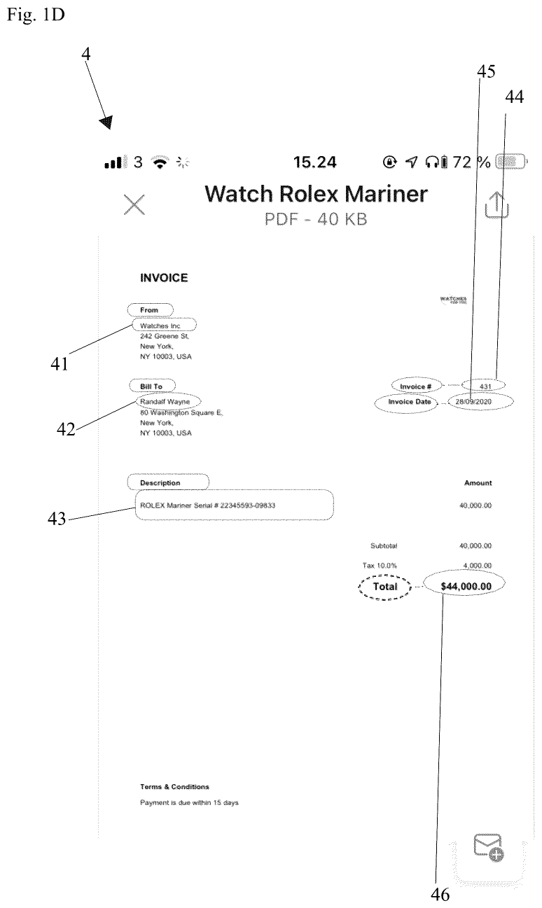

FIG. 1A-1D illustrate a first, second, third and fourth invoice document 1, 2, 3, 4. The invoice documents have identical data elements 11-16, 21-26, 31-36, 41-46 and all describe the same purchase of a watch. These are the kinds of documents, along with other documents, that insurance companies rely on today to determine whether to make a pay-out to a policy holder in case of a claim, such as of a fire or theft.

Each of these documents may be legitimate in and by themselves. One avenue of fraud arises when an invoice document is released onto the public internet or shared in other ways, either in private forums, chats or among friends. In such cases, the use of other people's invoices to substantiate a claim is illegitimate and an expression of fraud. However, it can be difficult for insurance companies to reasonably expect that an invoice is illegitimately used in a specific case for various reasons. From the second time onwards when a document is used, it is illegitimate.

The insurer may never have seen the invoice before, and even if they have, they may not be able to recognise it because it is an image of a print, and the document quality has deteriorated. Because documents are laid out in various manners among document producers, it is even a problem to accurately compare documents with character recognition software, since the data elements 11-16 have no intrinsic meaning to the reading machine.

The first document 1 may be substantially easier to analyse than the second invoice document 2 and especially the third invoice document 3 due to its higher data quality. To identify whether a document has been used before, it is useful to first be able to parse the document for text. Character recognition of various types can be used such as optical character recognition (OCR) or intelligent character recognition (ICR) or other types of character recognition. Identifying and extracting data from the first invoice document 1 may provide the following, where asterisks mark a shorthand of what can be found on the figure itself. The first document then has the following data elements, data objects and data tags:

| Reference | Data object | Type | Text |
|---|---|---|---|
| 11 | Seller identity | Data element | “Watches Inc” |
| 11A | Seller identity | Data tag | “From” |
| 11B | Seller identity | Supplementary data | Address* |
| 12 | Buyer identity | Data element | “Randalf Wayne” |
| 12A | Buyer identity | Data tag | “Bill To” |
| 12B | Buyer identity | Supplementary data | Address* |
| 13 | Item description | Data element | “ROLEX Mariner |
| | | | serial #*” |
| 13A | Item description | Data tag | “Description” |
| 14 | Invoice identity | Data element | “431” |
| 14A | Invoice identity | Data tag | “Invoice #” |
| 15 | Invoice date | Data element | “28/09/2020” |
| 15A | Invoice date | Data tag | “Invoice Date” |
| 16 | Invoice amount | Data element | “$44,000.00” |
| 16A | Invoice amount | Data tag | “Total” |

There is also supplementary data which may be used to improve document specificity for certain situations. The data tags of for example seller identity 11A helps ensure that documents can be compared on contents instead of overall graphical expression.

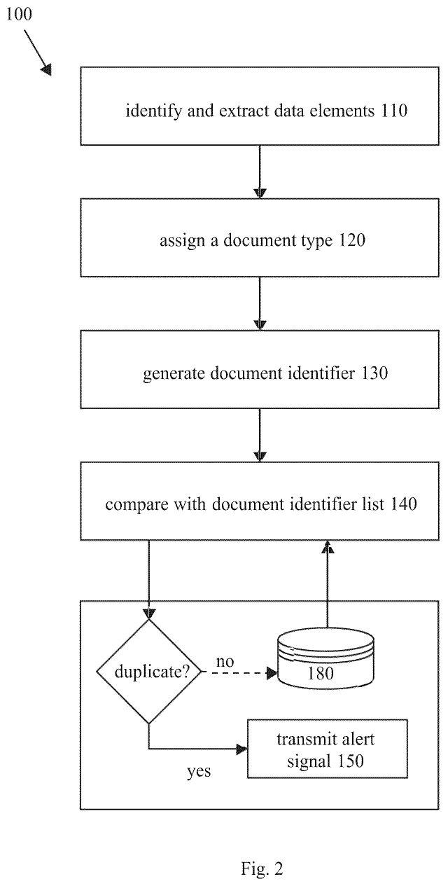

FIG. 2 illustrates the method 100 of the invention. FIG. 1 will be referred to generally throughout the description of FIG. 2 by the reference numerals of the first invoice 1 where it makes description of the method easier.

The first invoice document 1 is analysed to identify and extract the relevant data elements 11-16 from the document. Then, a document type 120 is assigned to the document, such as ‘invoice’ based on the presence of certain keyword data in the extracted data. Based on the document type 120, specific predetermined data elements are selected from among all extracted data elements. A data-unique document identifier is then generated 120. The document identifier 130 is then compared against a repository of previous document identifiers 140 stored in a database 180, generated for previous documents. After comparison, if the document identifier 130 matches a document identifier already stored in the database, an alert signal is transmitted 150. If it does not match a stored identifier, it is added to the database to prevent future fraud.

The method is described in more detail in the following.

In a first step, data elements are identified and extracted 110. The document can be provided in a variety of formats and qualities. If it is provided with embedded text such as by providing a portable document format (PDF) file with embedded vectorised text, no character recognition is necessary. Otherwise, if a document with only rasterised images of text is provided, character recognition is performed as part of identifying and extracting data elements 110. This is the case for PDF files with rasterised text which is typical of for example scanned documents. It is also the case for image files such as camera image files and screenshot files.

Then, when characters of the document are provided whether by character recognition or by the original document file, data objects, primarily text strings, are extracted for manipulation. The output of identifying and extracting can then be viewed as a raw text file.

Data elements, being prices, dates, numbers, codes and other pluralities of symbols taken together, can be identified and extracted on their own, or they can be extracted along with data tags 11A, 12A. For some data elements such as dates, their formatting works as identifier. The same is the case for addresses which also often has a specific formatting. For other data elements it may be necessary or at least beneficial to match the data element to a data tag 11A.

The data tags determine what the text or numbers of a data element means. For example, the “Invoice #” data tag 14A belongs to the data element “431” located to its left. For something like the invoice number, however, it is preferred to identify and extract data tags too.

In an embodiment, assigning a document type comprise contextualising extracted data elements by assigning at least one data element with a context by data element formatting such as for a date, and by pairing at least two data element to respective data tags provisionally based on proximity and row-alignment, and where when all data elements have context with the greatest overall proximity fit, the par-matches are finalised.

When the data elements have been identified, a document type 120 is assigned to the document based on the presence of at least one keyword data element 121. The keyword data element can be the title of the document, i.e., ‘invoice’, or it can be the specific text in the document, such as ‘invoice #’ and ‘invoice date’. All of these are specific to invoices and informs that the document is an invoice. It is important that the document type 120 is established, because the characterising data elements are different among different document types, and it is important to use characterising data elements for the later steps of the method.

Determining the document type can be performed by a fuzzy fit method, where different data fit algorithms are used. For example, the presence of several instances of ‘invoice’ establishes with a certain confidence, such as 80%, that the document is an invoice, while the presence of a social security number and free text latin medical expressions establishes with a certain confidence, such as 40% that the document is a medical journal entry. The document may then be considered an invoice. When the confidence scores are within a certain gap from one another, or all below a certain threshold, manual assistance may be requested by such method.

Consider the following example: Two documents are analysed, an invoice and a medical journal entry. For the medical journal entry, it is important to retrieve the social security number of the journal entry, as it will be specifying for that document. Therefore, the data element having the social security number necessary to retrieve for journal entries. However, certain invoices may be contemplated to also specify a social security number. If the social security number is considered important on invoices, different problems arise. Firstly, if they are always necessary, the method may not work at all for jurisdictions without social security numbers, and legitimate policy holders may be uncomfortable to provide them for claims. Secondly, if it is used ‘when present’, a fraudster can add a social security number to an invoice to change the behaviour of the method.

The document type 120 that is selected for the document, such as ‘invoice’, then has certain type data 122 associated with it. For example, invoice number, invoice date, buyer name and total amount may all be type data 122 for the invoice document type. When taken together, the type data can sufficiently uniquely identify the document while these are at least substantially always present. Alternatively, instead of buyer name, seller name may be used. In any regard, when the document type is determined, the type data 122 is determined, and specifies which characterising data are expected to be present in the document and sufficient to fully identify the document.

The document identifier 130 is then generated by selecting the document type 120 associated data elements and manipulating them some predetermined way. One manner is to append them into a string in a predetermined order. An especially useful manner is to append them in a string, then create a hash value from the string. By using a hash, it is easy and much faster to retrieve the document identifier when assessing uniqueness of a document, and it is more secure as no information can be gleaned by system administrators.

When the document identifier 130 has been generated, it is compared against a document identifier list 140 stored in a database. If the document identifier 130 matches with a document identifier from the list 140, the document has previously been fully used by a policy holder or other person to derive the benefits from the document, which can be legitimately used no longer. Therefore, the document is considered a duplicate, if it matches a document identifier from the list 140, and an alert signal 150 is transmitted. If the document identifier 130 does not match any document identifiers from the list 140, it is considered unique. A confirmation signal is preferably transmitted instead of the alert signal, and furthermore, the document identifier is preferably added to the document identifier list stored in the database 180.

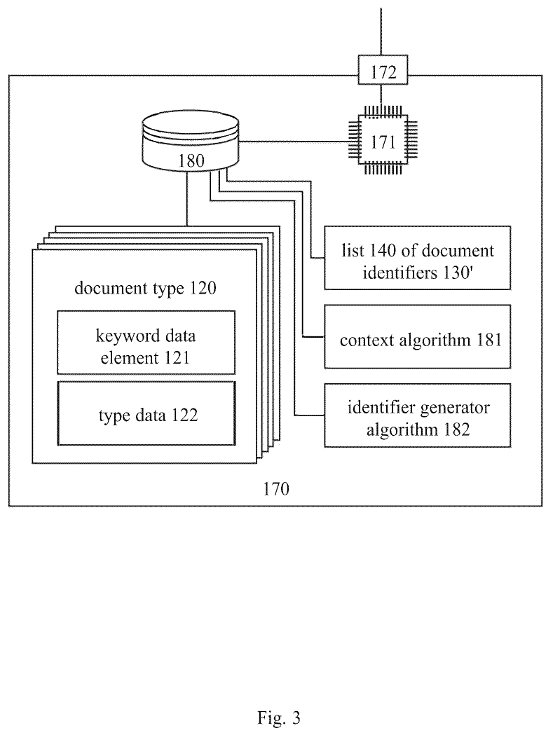

FIG. 3 is a conceptual illustration of a computing device 170 instructed to perform the method. The computing device 170 has a processor 171, a networking interface 172 and a database 180.

The networking interface 172 receives requests for document uniqueness verification from various devices, such as over a public internet. The networking interface 172 transmits the signal to the processor 171 for computation.

The processor performs the identifying and extraction of data elements and derives text strings.

A context algorithm 181 is preferably executed on the extracted text strings to determine the pairing of the data elements to certain data tags and/or data contexts.

When the data is contextualised, competing keyword data elements from different document types 120 are matched against the derived text. This can be performed on the data tags, the raw extracted text or on the formatting on the data elements and/or data tags. If the keyword data element(s) of one document type is clearly the best fit according to certain predetermined confidence requirements, the associated document type 120 is assigned to the document in question.

With a selected document type, the type data 122 is used to select a plurality of data elements from the extracted text. With the selected data elements, an identifier generator algorithm 182 generates a type data 122 unique document identifier. The generated document identifier is then evaluated against the list 140 of document identifiers 130′. If the newly generated document identifier matches at least one document identifier in the list, the processor 171 transmits an alert signal through the networking interface 172. Otherwise, a verification signal is transmitted instead, and the newly generated document identifier is added to the document identifier list 140.

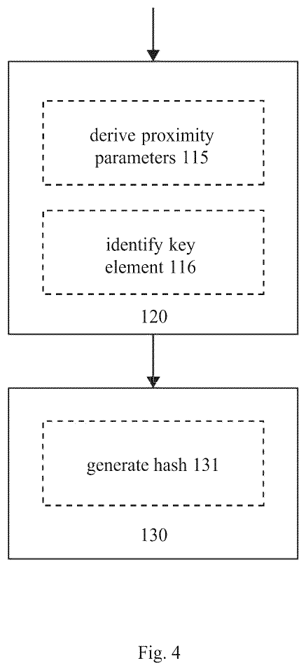

FIG. 4 illustrates assigning a document type 120 a generating a document identifier 130 including various preferable and optional sub-steps.

In an embodiment, the step of assigning a document type comprises deriving proximity parameters 115. First, enhanced context is provided to the extracted text. For example, characters are grouped as individual strings. Then, each string is determined to be a data element, or a data tag based on the content of the string. Certain predetermined words and terms are assumed to be tags while numbers and alphanumerical codes are assumed to be data elements. For example, ‘invoice #’, ‘invoice number’, ‘transaction’, ‘transaction nr.’ and others may all be to the same data tag. Each data tag will then be interpreted to one of a series of specified categories, such as the mentioned ‘invoice number’.

Proximity parameters 115 are derived for each tag and/or data element. Proximity parameters are the pixelwise distance between a string and its neighbouring strings as well as a tolerance for long horizontal distances, i.e. row-distances. The data tags and data elements are then paired to each other by an objective function that minimises the combined distance within paired strings. In an embodiment, an evolutionary or simulated fit is used where several fits are evaluated against each other for lowest combined distance among paired strings.

In an embodiment, a key element 116 of the document is used to further specify the document. For example, a logo that says ‘watches’ with an image of that company, such as the document in FIG. 1A, may inform, in combination with the document type ‘invoice’ to determine where in the document specific data elements can be found. This is accomplished using a predetermined mapping. This embodiment then uses a key element 116 to create context for at least one, preferably all data elements of the document.

1. A method of verifying the uniqueness of a digital document by:
identifying and extracting data elements of the document,
assigning the document with a document type based on the presence of at least one keyword data element among extracted data elements,
generating a document identifier based on type data being a predetermined plurality of the extracted data elements specific to said document type using an identifier generator algorithm,
comparing the generated document identifier with a list of document identifiers stored in a database, where
if the generated document identifier matches a document identifier in the list, the document is marked as a duplicate document and an alert signal is transmitted.

2. A method according to claim 1, where generating the document identifier comprises generating a hash based on said type data.

3. A method according to claim 1, where at least one data element is assigned a context using the arrangement and/or structure of the data element, such as using backslash and dash character spacing of dates and line spacing of addresses.

4. A method according to claim 1, where at least two data elements are assigned contexts by being paired with respective data tags of the extracted text, the pairing of data elements to data tags performed by evaluating at least row-alignment and proximity of the data element and data tag, where each data tag can only pair to a single data element, and where the overall fit of all pairs determines a confidence score of the paring.

5. A method according to claim 1, where the type data comprise a tiered predetermined list of data elements ranging from the most preferred to least preferred data element, where the type data is identified in the extracted data elements by first preselecting a plurality of most desired data elements, and where if any of these data elements cannot be found in the extracted data elements, alternate data elements are selected from the tiered list in turn of preference until complete type data is formed.

6. A method according to claim 1, where the method comprises a step of assessing the trust score of the identifying and extracting step to determine whether the document has been analysed with sufficient confidence, and where if the assessing the trust score determines a trust score below a certain threshold, a manual assistance is required to provide data elements including contents.

7. A method according to claim 1, where the method comprises a step of assessing the trust score of the assigning a document type step to determine whether the document has been assigned a type with sufficient confidence, and where if the assessing the trust score determines a trust score below a certain threshold, a manual assistance is required to provide data elements including contents or manually assigning document type.

8. A computing device having a processor adapted to perform the steps of claim 1.

9. A computer program comprising instructions which cause the computer to carry out the method of claim 1 when the program is executed by a computer.

10. A computer-readable medium comprising instructions which cause the computer to carry out the method of claim 1 when executed by a computer.
